(19) United States
(12) Patent Application Publication
(10) Pub. No.: US 2023/0182225 A1
(43) Pub. Date: Jun. 15, 2023

(54) ARC WELDING, CLADDING, AND ADDITIVE MANUFACTURING METHOD AND APPARATUS

(71) Applicant: The ESAB Group Inc., North Bethesda, MD (US)

(72) Inventor: Christopher Hsu, Elkridge, MD (US)

(21) Appl. No.: 18/162,917

(22) Filed: Feb. 1, 2023

Related U.S. Application Data
(63) Continuation of application No. PCT/US2021/045340, filed on Aug. 10, 2021.
(60) Provisional application No. 63/064,518, filed on Aug. 12, 2020.

(51) Int. Cl. B23K 9/10; B23K 9/167; B23K 9/28; B23K 9/173; B23K 9/095; B23K 9/08; B23K 9/26

(52) U.S. Cl. CPC B23K 9/1043; B23K 9/167; B23K 9/285; B23K 9/173; B23K 9/095; B23K 9/08; B23K 9/26

(57) ABSTRACT

An arc welding apparatus and corresponding method includes a torch, a non-consumable electrode and a consumable electrode both disposed within the torch, a wire feeder configured to feed the consumable electrode in a vicinity of the non-consumable electrode, a first power source and a second power source that provide independent current, respectively, to the non-consumable electrode and the consumable electrode, and a weld process controller to control outputs of the first power source and the second power source such that a concentrated arc is formed, as a heat source, between the non-consumable electrode and a workpiece, and an inter-electrode arc is formed between the consumable electrode and the non-consumable electrode to melt the consumable electrode. The approach is characterized by low heat input, low distortion, low spatter, and the relative high speed or high deposition of laser and laser-MIG hybrid and other forms of multi-wire/multi-electrode welding, cladding, and additive manufacturing.

### CROSS-REFERENCE TO RELATED APPLICATION

This application is a continuation of International Patent Application No. PCT/US2021/045340, filed Aug. 10, 2021, which claims the benefit of U.S. Provisional Patent Application No. 63/064,518, filed Aug. 12, 2020, the entire contents of which are incorporated herein by reference.

### TECHNICAL FIELD

The subject disclosure relates to multi-electrode welding, or cladding, or additive manufacturing characterized by a wide range of applications, from high penetration, high deposition, or high-speed processing for a thick workpiece or surface cladding, to low heat input or low distortion or precision process control for a thin workpiece. The subject disclosure is also related to independent control of deposition and heat input for an additional degree of freedom in process optimization in both weld quality and productivity.

### BACKGROUND

Innovations in welding have been abundant in the last decade and have helped to drive up productivity and drive down cost both in heavy plate welding with high deposition rates and in thin thickness or heat-sensitive material welding with lower heat input.

U.S. Pat. No. 9,233,432B2 and US201401334A1 disclose a dual-electrode torch or weld head designs, and two separate current sources to deliver power. There are two arcs connected at one end to one electrode and split at the other end to the other electrode and the workpiece. The two arcs are powered by two separate current sources. The current in between the two electrodes is called the bypass current. One variant of this type of process is called arcing-wire gas tungsten arc welding (GTAW), where the common end of two arcs comprises a non-consumable electrode and a consumable electrode. The GTAW arc disclosed is conventional without means of energy concentration. US20140367365A1 discloses a dual consumable electrode welding method with a bypass current between the two electrodes. U.S. Pat. No. 8,278,587B2 discloses a three-electrode torch with two electrodes conducting bypass current as disclosed in U.S. Pat. No. 9,233,432B2. U.S. Pat. No. 8,895,896B2 teaches a 3-electrode series arc system for submerged arc welding. KR101649496B1, JP2009072802A and U.S. Pat. No. 7,235,758B2 teach various plasma-MIG hybrid torches. The torch and system in U.S. Pat. No. 7,235,758B2 is commercially known as SuperMIG.

Higher deposition welding can be achieved by single or multiple wire sub-arc welding, or single-wire buried arc, or multiple-wire gas metal arc welding (GMAW) either with electrode isolation, known as tandem arc, or without isolation, known as twin arc. Due to the fluidity of the pool and flux system, sub-arc welding is typically limited to butt joints in the flat position and fillet joints in both the flat and horizontal-vertical positions. JP2017144480A discloses a single-wire, buried-arc GMAW process at very high wire speed and welding current where the process stability is improved by low-frequency pulse modulation of current or voltage, commercially known as D-Arc. Another single-wire higher deposition example is disclosed in U.S. Pat. No. 10,675,699B2, which describes a GMAW torch with two contact tips to preheat wire to achieve single-wire high deposition.

As an example of twin GMAW for high deposition, US20190047076A1 and U.S. Pat. No. 10,532,418B2 disclose two consumable electrodes being fed into a common contact tip with two orifices at close proximity where the droplets from both electrodes are combined and transferred towards the weld pool together, also known commercially as HyperFill. More complex arrangements exist, such as twin-wire plus an electrically isolated and unpowered or cold wire in between the two powered electrodes disclosed in U.S. Pat. No. 9,937,581B2, commercially known as ICE.

EP1459831 and EP1459831A2 disclose a tungsten inert gas (TIG) torch in which a wire feeding guide opens into the side of the shielding gas nozzle, also known commercially as TOPTIG.

Keyhole GTAW is a welding process where the arc plasma of TIG is concentrated by a non-consumable electrode design and cooling so that arc energy concentration can be achieved. WO2010045676A1 discloses a torch design with a heavy copper heat sink in the torch to remove heat, commercially known as K-TIG.

EP2008750A1 discloses a GTAW torch to achieve plasma energy concentration by intensive cooling at the non-consumable electrode tip end for thermal emission at the cooler cathode. Coupled with a high-capacity chiller, the welding process is commercially known as InFocus.

CN104985303A describes a method of combining TOPTIG and InFocus in a twin arc arrangement.

Hotwire TIG is a process that characterizes the combination of a TIG arc and a preheated wire consumable electrode typically fed from the side, and typically resistively heated, as disclosed in U.S. Pat. No. 4,614,856A, where the wire is electrically shorted to the workpiece and preheated resistively by a power source delivering a current between the wire and the workpiece. A variant of this process replaces TIG with a high intensity energy source such as a laser, as disclosed in U.S. Pat. No. 10,086,461B2 with the hot wire shorted to the workpiece. U.S. Pat. No. 10,675,699B2 discloses a method of pre-heating wire by two separate contact tips without shorting the wire into the workpiece and feeding the pre-heated hot wire into a laser energy source. AT4598U1 discloses a variation of a hotwire TIG process where the TIG wire is vibrated by a wire feeder with a pendulum stroke movement to increase travel speed, commercially known as TipTig. A bi-cathode cladding process, commercially known as TIGer also alleges higher deposition and lower dilution for weld overlay.

Fabricators value uptime and need simple and reliable solutions in production. Multi-wire solutions for higher deposition or higher speed welding typically add complexity due to arc interaction and risk of arc instability and feeding instability, which may geometrically increase as a function of the number of wires and/or arcs at the business end of the weld head. Single wire solutions are often limited due to the marginal increase in the deposition rate and limited to heavy plate welding due to the increased heat input. To reduce heat input but maintain high deposition, a laser energy source can be used, but laser usage suffers from adoption due to, among other factors, much higher capital cost. Therefore, there is a demand for a low-cost, simple, yet high deposition and controllable heat input process.

On the opposite side of the spectrum, a vast number of techniques have been proposed on modified short arc welding for thin gauge material welding, root pass of pipe, and aluminum welding where lower heat input and spatter reduction are among the keys to success. There continues to be an appetite for a simple yet effective solution for low heat and low fume applications.

### SUMMARY

A method and apparatus for arc welding are disclosed, where the arc energy is generated from a non-consumable electrode, and the arc energy is split into a broadened plasma to spread over, pre-heat, and melt a consumable wire electrode, and another sharpened plasma jet with focused intensity is arranged to melt the workpiece. The two arcs can be separately regulated to independently control the consumable wire electrode melt rate and the workpiece heat input.

### BRIEF DESCRIPTION OF THE DRAWINGS

FIG. 1A is a diagram illustrating components and interconnections of an arc welding/cladding system with a mix of consumable and non-consumable electrodes and power sources for generating arcs, according to an example embodiment.

FIG. 1B is a diagram illustrating components and interconnections of an arc welding/cladding system with a mix of consumable and non-consumable electrodes and power sources arranged differently compared to that shown in FIG. 1A, according to an example embodiment.

FIG. 1C is a diagram illustrating components and interconnections of an arc welding/cladding system having multiple non-consumable electrodes and a consumable electrode, and power sources, according to an example embodiment.

FIG. 2A is a diagram illustrating a torch design featuring a racetrack or oval shielding gas nozzle, and side-by-side positioning of consumable and non-consumable electrodes where non-consumable arc concentration is achieved through supercooling of the electrode, according to an example embodiment.

FIG. 2B is a diagram illustrating a torch design featuring a racetrack or oval shielding gas nozzle, and side-by-side positioning of consumable and non-consumable electrodes where non-consumable arc concentration is achieved through a plasma constricting nozzle, according to an example embodiment.

FIG. 3 is a diagram illustrating a torch design featuring a round shielding gas nozzle, and a non-consumable electrode holder entering the nozzle from the side, according to an example embodiment.

FIG. 4 is a diagram of a torch design featuring a racetrack or oval shielding gas nozzle, and two consumable electrodes that operate with an inter-electrode arc in between, according to an example embodiment.

FIG. 5A is a diagram of a torch design featuring a round shielding gas nozzle with a wire in the middle, and a one-piece, non-consumable electrode around the wire, according to an example embodiment.

FIG. 5B is a diagram of a torch design featuring a round shielding gas nozzle with a wire electrode in the middle, and a multi-segment, non-consumable electrode around the wire electrode, according to an example embodiment.

FIG. 6 is a diagram of a torch design featuring three consumable electrodes for submerged arc welding with a center electrode electrically isolated from the other two electrodes, according to an example embodiment.

FIG. 7A is a diagram of a 3D-printed non-consumable electrode design, according to an example embodiment.

FIG. 7B is a diagram of a 3D-printed non-consumable electrode design with an alternate internal cooling channel design, according to an example embodiment.

### DETAILED DESCRIPTION

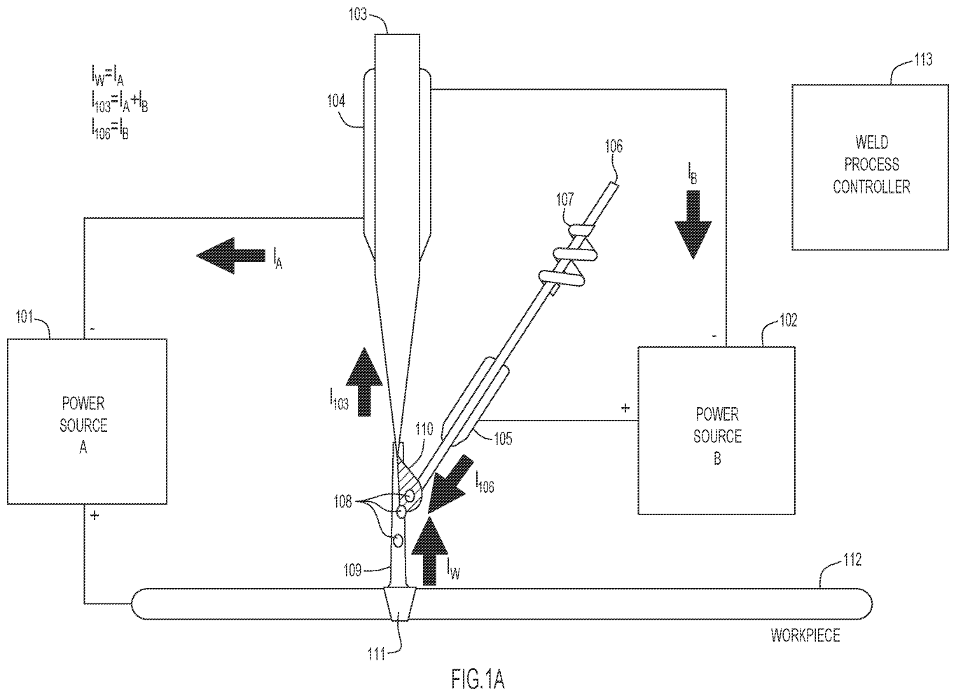

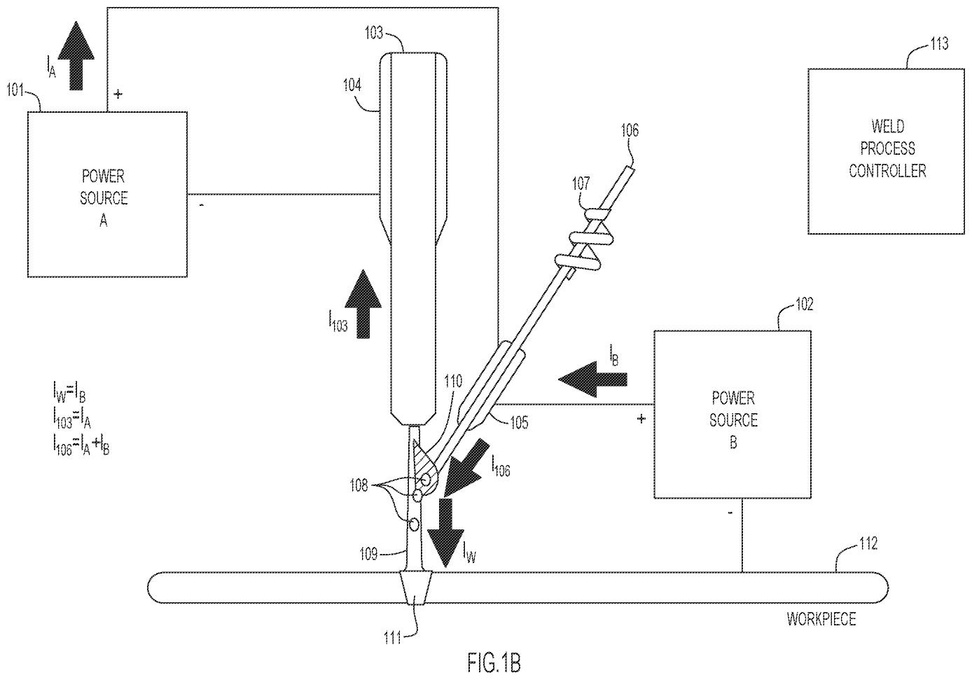

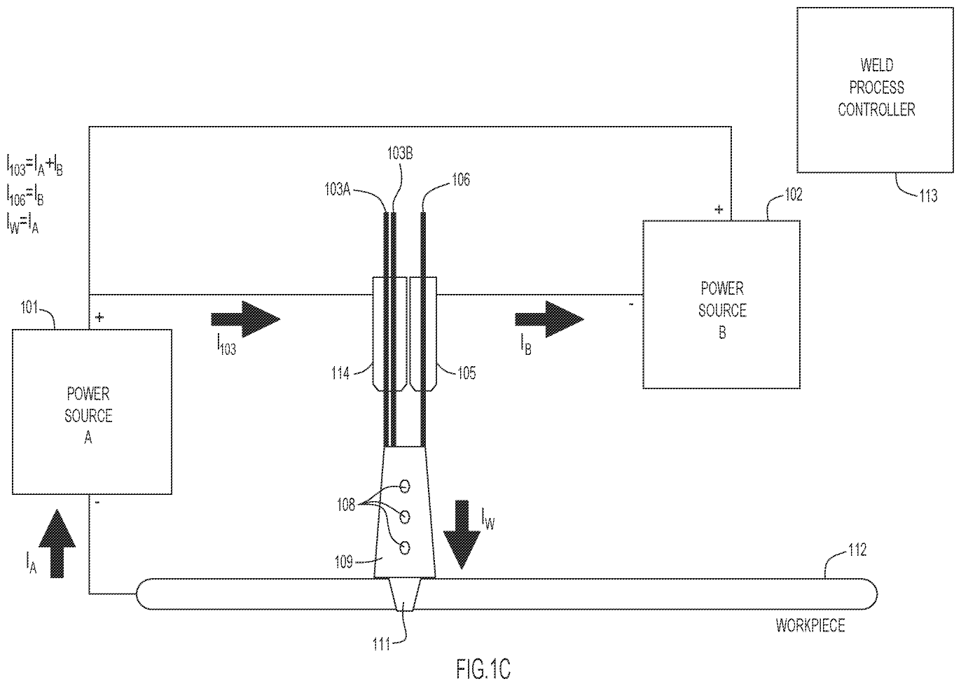

Referring to FIG. 1A, a welding and/or cladding system comprises a power source A 101 to deliver arc current between a non-consumable electrode 103 (e.g., a thoriated tungsten electrode), held by an electrode holder 104, and a workpiece 112. A wire feeding device 107 feeds a consumable electrode 106 (e.g., a wire), and a power source B 102 delivers arc current between non-consumable electrode 103 and consumable electrode 106. An arc 109 extends from the end of non-consumable electrode 103, and arc 110 extends from consumable electrode 106 to arc 109. A weld pool 111 is covered by shielding gas (not shown). Arc 109 heats the workpiece and may also be referred to as workpiece heating arc 109. Arc 110 between the two electrodes may also be referred to as an inter-electrode arc 110.

One feature of the present embodiment is independent heating of the consumable electrode 106 and heating of the workpiece 112. The heat input to the workpiece 112 comes from the workpiece heating arc 109 where power source A 101 controls I_{A} which equals I_{w}, the current passing through the workpiece 112. The portion of consumable electrode 106 that extends beyond contact tip 105 is heated resistively by the output current I_{B} of power source B 102 and from the inter-electrode arc 110. Increasing current I_{B} or I₁₀₆ for higher wire deposition or melt-off rate does not largely affect the workpiece heat input corresponding to I_{w}. A human-machine interface (HMI) may accompany weld process controller 113 to allow a user to control the heat input and deposition independently.

Another feature of the present embodiment is a focused or higher energy density arc between the non-consumable electrode 103 and a workpiece 112 to form weld pool 111 that can form a keyhole in the weld pool 111 and deeper penetration in (a thick) workpiece 112. The arc concentration can be accomplished by a non-consumable electrode design and its cooling or a physical or magnetic mechanism to compress or constrict the arc 109, thus changing the arc shape and energy concentration of the arc 109 to achieve higher energy density compared to a conventional TIG arc. While a plasma arc with a constricting nozzle can also focus arc energy, it has the complexity of cooling the constricting nozzle and the high wear rate of torch consumables.

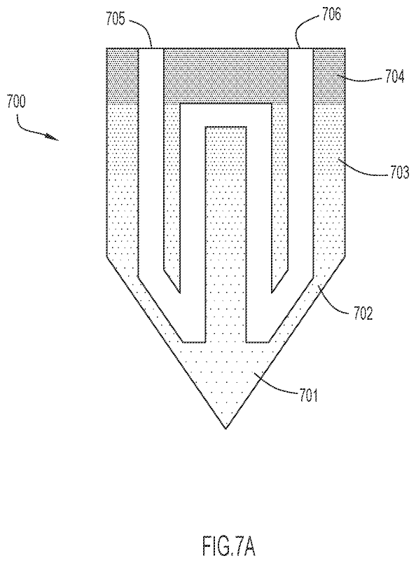

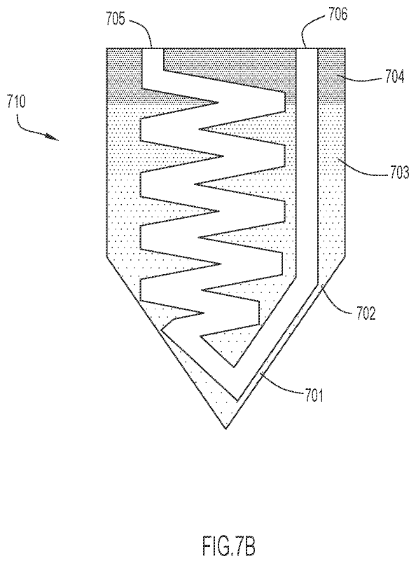

Without using physical means to constrict the arc 109, with high enough energy density it is possible to achieve a keyhole in the weld pool 111. This is known as keyhole TIG, and may be achieved by super-cooling the non-consumable electrode 103. One method of enhanced electrode cooling is to optimize the heat sinking capability of a liquid-cooled electrode holder. Another method is to increase the thermal connectivity between the non-consumable electrode 103 and electrode holder 104. More specifically, the junction between non-consumable electrode 103 and electrode holder 104 may be made via back-casting of the refractory metal electrode or diffusion bonding or brazing or hot isostatic pressing and a thermal, more conductive, metal holder in a mold, thereby forming a solid or metallurgical bond with a few micrometers in thickness absent of discontinuity. See, e.g., U.S. patent application Ser. No. 17/104,134, field Nov. 25, 2020, entitled “Hyper-TIG Welding Electrode.” Yet another method is to employ a high-capacity liquid chiller (e.g., 10,000-14,000 BTU/hour or higher). A fourth method involves geometry optimization of the non-consumable electrode 103. A fifth method comprises additively manufacturing non-consumable electrode 103 with an optimized interior liquid channel and functionally graded material (see, e.g., FIGS. 7A and 7B, discussed later herein). A sixth method is active flux TIG or A-TIG. Of course, these methods may be combined to arrive at a fitness-for-purpose and cost-effective solution.

By combining high arc energy density and inter-electrode current, the arrangement illustrated in FIG. 1A presents a viable alternative to laser or a laser-MIG hybrid, but at a fraction of its cost. These two features are complementary. The high energy density is employed to increase penetration and thermal efficiency, and the inter-electrode current assures no excessive heat is delivered into the workpiece 112 by separately controlling the wire heating without affecting workpiece heating. The consumable electrode 106 is often needed for certain joint designs (e.g., fillet) and also for production robustness, as the tolerance of many joints is not good enough for autogenous welding without wire. These problems are possibly solved by a laser-MIG hybrid process due to the energy density of laser and the forgiveness of MIG, and the disclosed system solves the same problems with high energy density (less than laser but much higher than conventional arc). Also, for certain joints, e.g., T-fillet, it is required to capture root (i.e., root joint penetration) and at the same time maintain a smooth bead shape especially at the weld toes to improve fatigue life. Conventional arc welding relies on selecting welding parameters to trade off these opposing needs, often resulting in a compromise. According to the disclosed design, independent control of penetration and wire deposition is achieved so that these two optimizations can be reached much more easily and in a superior manner.

FIG. 1B shows a similar circuit to that shown in FIG. 1A, but in FIG. 1B a circuit is completed between the workpiece 112 and the consumable electrode 106, instead of the non-consumable electrode 103 being couple directly to the workpiece 112, according to an example embodiment. The wire melt-off is controlled by I₁₀₆ which, in this case, equals I_{A} plus I_{B}. The current I₁₀₃ to the non-consumable electrode 103 is reduced compared to I₁₀₃ in FIG. 1A. It is noted that not all the current I₁₀₆ used to melt the consumable electrode 106 heats the workpiece 112 because a portion of it is diverted or bypassed by the non-consumable electrode 103 as I₁₀₃ or I_{A}.

FIG. 1C is a diagram illustrating the key components and interconnections of an arc welding/cladding system having multiple non-consumable electrodes and a consumable electrode, and power sources, according to an example embodiment. Specifically, two non-consumable electrodes 103A and 103B are electrified by a contact tip/contact jaw 114 and are connected to power source A 101, while consumable electrode 106 is electrified by a contact tip 105 and connected to power source B 102. The current passing through non-consumable electrodes 103A and 103B combines I_{A} and I_{B}. The current passing through consumable electrode 106 in FIG. 1C is I_{B}. The current I_{w} to the workpiece 112 is the same as I_{A} and not the total current to electrodes 103A, 103B, and 106, therefore higher deposition can be achieved without higher workpiece heat input.

Due to the independent control of the heat input and deposition, it is possible to maintain a constant heat input, constant deposition, and weld process stability despite stick-out changes (i.e., the gap between the contact tip for the consumable electrode 106 and workpiece 112), especially when the welding torch is held by hand when compared with MIG or GMAW or some SAW processes. When MIG stick-out changes, the welding power source in constant voltage (CV) regulation may change the welding current to melt the wire faster or slower to avoid arc outage. However, this will change the heat input and may put weld quality at risk. Instead of changing welding current, some systems change the deposition/wire feed rate to maintain process stability. However, this approach may change deposition and bead size which may not be acceptable to meet weld size specifications. The system arrangement illustrated in FIGS. 1A and 1B can operate in a constant current mode for the workpiece heating arc 109 and thus provide constant heat input to the workpiece 112, and a constant deposition rate due to a constant wire speed by wire feeder 107. Since the physical distance between contact tip 105 and non-consumable electrode 103/holder 104 is fixed and not affected by torch body movement relative to workpiece 112, the inter-electrode arc 110 length is very stable. This approach has a greater assurance of weld quality (e.g., mechanical properties, defect-free, and weld size) than conventional MIG processes.

In automated welding with sensors, such as a vision system in robotic adaptive welding, a variable deposition is often needed to match with the joint opening being observed by the camera. For example, more fill is needed when the joint opens up due to poor joint preparation or distortion during welding. In conventional MIG welding, more deposition usually means more heat input because the extra heat for melting the extra wire deposit is also experienced by the workpiece. Since deposition is decoupled from heat input, the adaptive fill algorithm can adjust deposition based on the observed fill volume without the fear of the side effect of failing a quality assurance (QA) test, e.g., by having poor Charpy values.

The decoupling of heat input and deposition can be pushed to the extreme in the case of cladding, or surfacing, for corrosion protection or wear protection (hardfacing). The goal is often minimum base metal dilution to meet required specifications (e.g., 5% iron dilution in a single overlay layer), and the secondary goal is to clad as fast as possible, e.g., measured by square centimeters per minute which may rely on a motion device as well, or kilograms per hour in terms of deposition. In this case, turning down the I_{w} in the workpiece heating arc 109 and turning up the inter-electrode arc 110 current and wire speed would produce much better results than MIG or hotwire TIG due to the decoupling effect, again closer to a laser hotwire process but without its high capital cost.

Turning down I_{w} in workpiece heating arc 109 to a very low level also enables ultralow heat applications, such as thin gauge material, aluminum, corrosion-resistant alloys (CRA), and pipe open root joints. This process naturally has low spatter because the metal transfer does not rely on short-circuiting. It is unlikely that the liquid droplets will short circuit to the weld pool, and keeping the workpiece heating arc current low will ensure that not much heat is directed towards the base material.

It is possible to use constant voltage (CV) to control the current of inter-electrode arc 110 and rely on self-regulation of the inter-electrode current to maintain arc stability. Since the distance between contact tip 105 and the distal end of the non-consumable electrode 103 is fixed, the inter-electrode current may not fluctuate much to affect radiated bypass heat fluctuation into the workpiece 112. To maintain arc gap or arc voltage between the electrodes and the workpiece 112, it is possible to adjust inter-electrode current only to control the wire melt-off rate without changing I_{w}.

It is possible to pulse the two currents in a synchronized way by weld process controller 113. For example, weld process controller 113 can command a high current in workpiece heating arc 109 but low current in inter-electrode arc 110, followed by a high current in inter-electrode arc 110 and low current in workpiece heating arc 109, and the cycle can repeat. This may allow out-of-position welding and also further reduce the heat input.

For arc start and arc end, it may be possible to synchronize the ramp of the power output of power sources A 101 and B 102 along with the wire feed rate to minimize humpy bead at the start or large crater at the end.

Although the power sources depicted in FIGS. 1A-C are DC power supplies, both power source A 101 and the power source B 102 can be either direct current (DC) or alternating current (AC). It is also preferable to employ switch-mode power sources such as inverter or buck converter, which have advanced pulse capabilities.

The consumable electrode 106 (i.e., wire) is fed by a wire delivery device (e.g., a wire feeder) such as a 2-roll or 4-roll drive. Optionally, the wire delivery is through a planetary gear feeding mechanism shown as wire feeding device 107 for higher “feedability,” especially for softer wires.

The incident angle between non-consumable electrode 103 and consumable electrode 106 is optimized for arc stability and reliable arc start, and is preferably between 10 and 45 degrees. It is also possible to have wire straighteners (not shown) to build elastic deformation into the wire so that it exits contact tip 105 curving downward to meet inter-electrode arc 110 with more surface area to facilitate wire melting. It is still also possible to have a curve-shaped wire guide or even contact tip 105 to curve the consumable electrode 106.

As referred to already, also shown logically in FIGS. 1A-1C is weld process controller 113, which regulates current for both power sources A 101, B 102 and synchronizes them. Weld process controller 113 may comprise a processor and/or computer, and logic/software instructions, stored therein on non-transitory media, that when executed cause weld process controller 113 to control the levels of arc current and voltage as described herein. Current for workpiece heating arc 109 controls penetration and heat input, and current for inter-electrode arc 110 controls wire melt-off rate and should match the wire feed rate controlled by wire delivery device 107, which together control the deposition rate.

Although power source A 101, power source B 102, and weld process controller 113 are shown as logical boxes in FIGS. 1A-1C, they can physically reside inside one case or housing. Likewise, power source A 101 and power source B 102 could be a single power source, but with multiple outputs.

In an automated process where the torch comprising the electrode holder 104 is held by a mechanized motion device, e.g., a robot, automatic arc length control can be implemented by monitoring the arc voltage and automatically having the robot adjust the arc gap between electrode non-consumable electrode 103/consumable electrode 106 and workpiece 112.

From a synergic control perspective, it is possible to design waveforms (also known as synergic lines in Europe) exposing users to two independent high-level parameters—heat input and deposition.

Although FIG. 1A shows the consumable electrode 106 heating being achieved by inter-electrode current I₁₀₆ in inter-electrode arc 110 and resistive heating of wire extension beyond contact tip 105, it is also possible to resistively preheat the wire before being melted by inter-electrode arc 110 in the end. The resistive pre-heating can be achieved by two contact tips (adding another contact tip upstream from contact tip 105 and apply AC current between the two contact tips to avoid magnetic interference (not shown). This of course adds complexity but may gain additional control over the deposition rate and flexibility to recover from arc faults or other process instabilities.

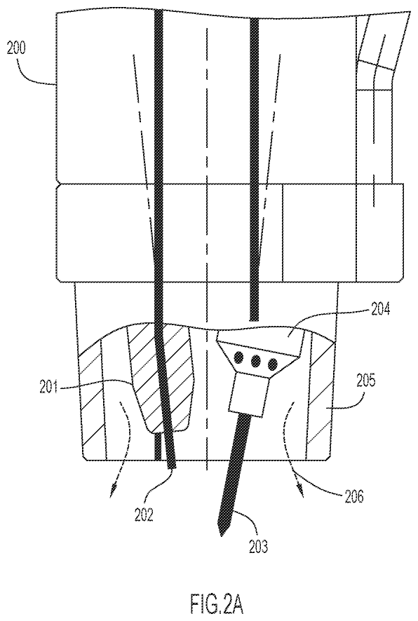

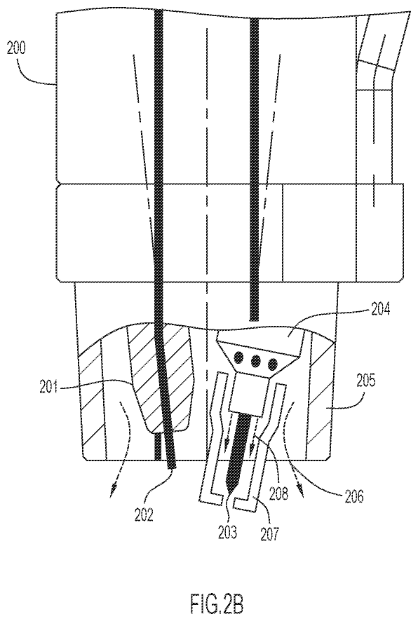

Referring to FIGS. 2A and 2B, a torch body 200 comprises a racetrack oval-shaped shielding gas nozzle 205 that encloses a contact tip 201 configured to advance a consumable wire electrode 202 and a non-consumable electrode 203 and its liquid-cooled holder 204. Gas nozzle 205 provides laminar shielding gas flow 206 around the two electrodes 202, 203, an inter-electrode arc between the two electrodes, and the weld pool under the electrodes 202, 203 (not shown). The two electrodes 202, 203 are preferably held at a small angle and the distal ends of the electrodes 202, 203 are preferably spaced 1-8 mm apart. The angle is employed to provide more room for liquid-cooled holder 204 for cathode heat dissipation. The racetrack oval shape of the gas shielding nozzle 205 may be the most compact design to house both electrodes side-by-side. FIG. 2A achieves arc concentration via super-cooling of non-consumable electrode 203 by the means disclosed above, while FIG. 2B achieves the same with a plasma constricting nozzle 207 and plasma gas 208 with pressure and energy density buildup by the nozzle orifice.

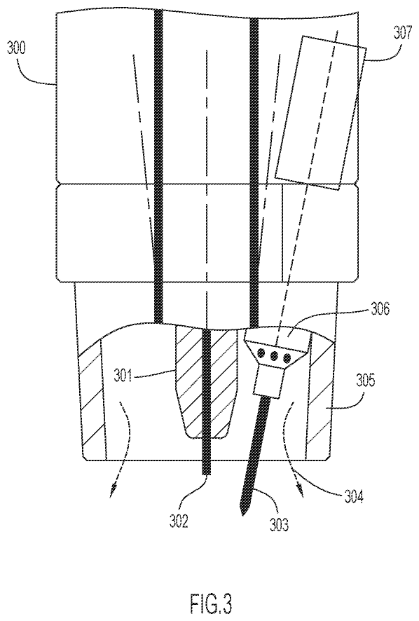

FIG. 3 shows a torch body 300 comprising a shielding gas nozzle 305, which is round-shaped and therefore symmetrical and omnidirectional regardless of how the torch is held relative to the joint. This may offer better programmability in robotic welding and may also be more friendly to human operators when used in manual welding. A wire delivery and current transfer contact tip 301 advances a consumable wire electrode 302 and is positioned in the center of the torch body 300. A non-consumable electrode 303, along with its holder 306 within a body 307, are introduced from the side of torch body 300 at an angle to a central axis of torch body 300. Shielding gas nozzle 305 encloses both consumable wire electrode 302 and a non-consumable electrode 303 and provides laminar shielding gas flow 306 around the two electrodes 302, 303, the inter-electrode arc between the two electrodes, and the weld pool under the electrodes (not shown). When torch body 300 is held by an automated tool manipulator such as a robot, non-consumable electrode 303 may be used as a tool center point (TCP) for precise and repeatable arc placement, so that the weld alignment relative to the joint position is less sensitive to the movement of consumable wire electrode 302 due to wire cast and helix. Similar to the arrangement in FIGS. 2A and 2B, the ends of the two electrodes 302, 303 are preferably spaced 1-8 mm apart.

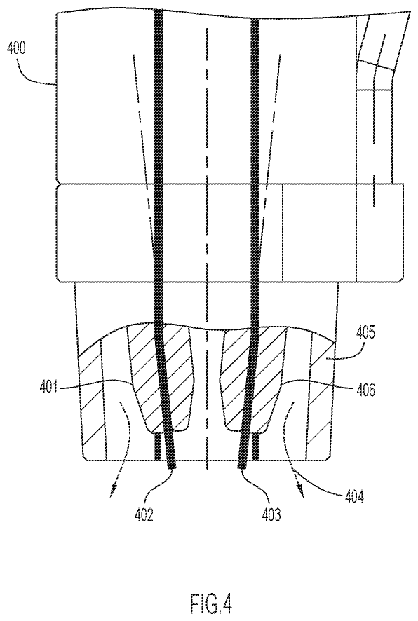

FIG. 4 shows a torch body 400 that houses two electrically isolated contact tips 401, 406 each capable of delivering current to its respective wire (consumable) electrodes 402, 403. The circuit depicted in FIG. 1C may be used to supply current where 402 in FIG. 4 corresponds to 103A or 103B in FIG. 1C (one electrode instead of two), and 403 in FIG. 4 corresponds to 106 in FIG. 1C. A nozzle 405 encloses both wire electrodes 402, 403 and provides laminar gas flow 404 around the two wire electrodes 402, 403, the inter-electrode arc between the two electrodes, and the weld pool under the electrodes (not shown). Instead of using constant current (CC) for the workpiece heating arc, and constant voltage (CV) for inter-electrode current, both circuits can be configured to run CV, but at different voltage settings. The wire feed rates of two wires may or may not be equal. It is also preferable that the ends of the two consumable electrodes 402, 403 are spaced about 1-8 mm apart. Similar to the principles of the configuration shown in FIGS. 1A, 1B, and 1C, deposition and heat input may be controlled independently, but differently. The torch design of FIG. 4 is similar to a tandem MIG configuration with two electrically isolated contact tips. That said, the process described herein has additional controllability and has the potential to have much lower heat input than conventional tandem MIG without losing deposition.

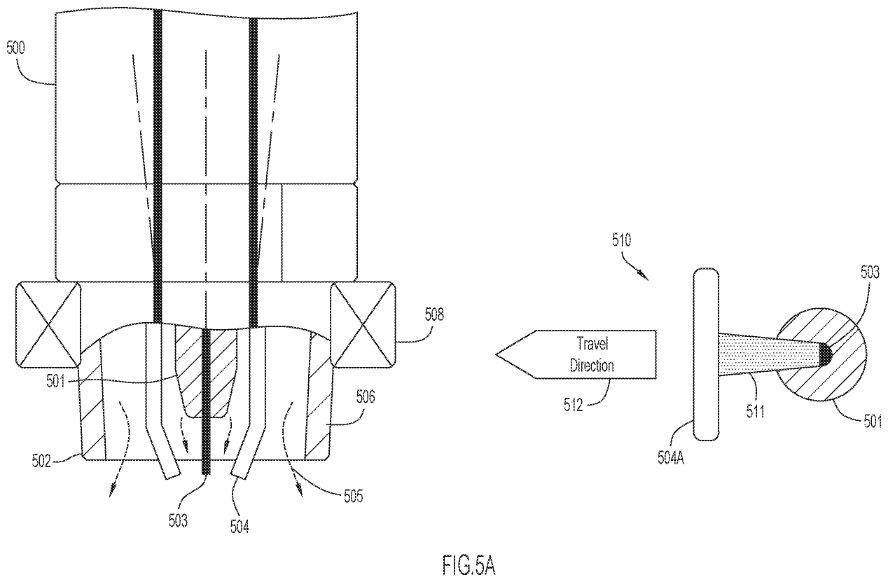

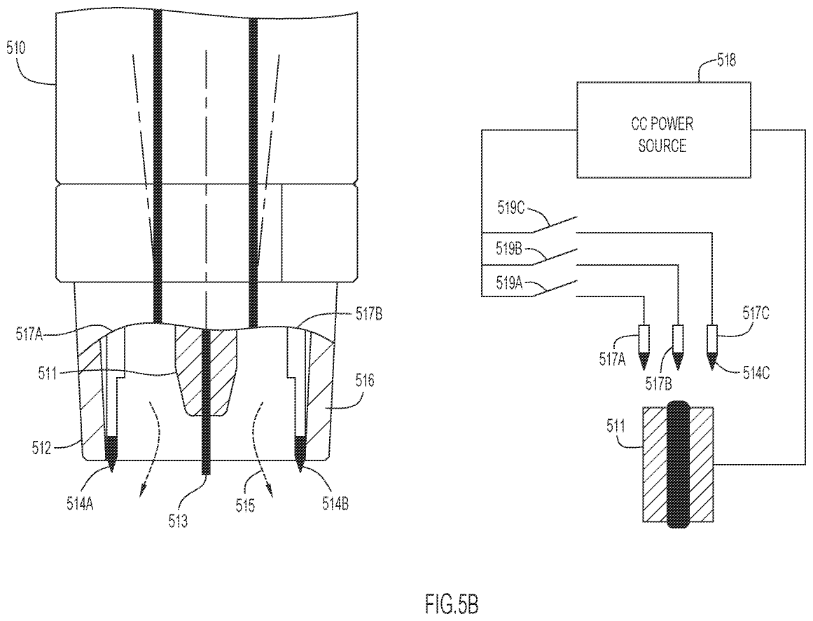

In large surface area cladding, a wider arc, as opposed to a focused arc, can lower arc pressure, allowing a higher arc current for faster cladding speed. Therefore, a non-consumable electrode without a sharp end or focus may be considered for producing a wider arc. FIG. 5A shows a torch body 500 having a round and symmetrical design with a tube-shaped, or cone-shaped non-consumable electrode 504 positioned coaxially inside a shielding gas nozzle 502 and surrounding (symmetrically) consumable wire electrode 503. The non-consumable electrode 504 is held by a heat sink (not shown) to conduct heat away from the non-consumable electrode 504, preferably liquid cooled. After a consumable wire electrode 503 exits centrally located contact tip 501 like a conventional MIG torch design, it is heated immediately by the inter-electrode arc or current flowing between electrodes 504 and 503 and melts into droplets to be deposited. Shielding gas nozzle 502 shields both electrodes 503, 504 and provides laminar gas flow 505 around the two electrodes 503, 504.

For the arc to distribute evenly across the entire tube at a wider range of current levels, a magnetic field former 508 may be added adjacent the nozzle to ensure the spread of the arc evenly around the tube of the non-consumable electrode 504. Although the non-consumable electrode 504 may be a tube for best symmetry or omnidirectional travel, it is possible to use an arc or partial tube segment to replace a pointed end of the non-consumable electrode 504. FIG. 5A also resembles a conventional MIG or TIG torch and thus is much friendlier for manual welding operators to adopt. Another variation of the design of FIG. 5A is shown in detail 510 (top view), with a flat or rectangular ended single piece non-consumable electrode (504A) to spread the workpiece heating arc in a line (instead of curved or circular shape) and to orient it to be perpendicular to the travel direction 512 for cladding. The inter-electrode arc for wire heating is shown as 511. Due to the field former or magnetic probes or other mechanisms of magnetic steering, the workpiece heating portion of the arc will spread across the clad surface with less arc pressure, enabling faster cladding speed. It is preferred to use the circuit described in FIG. 1B to maximize the melt-off rate of electrode 503 corresponding to 106 in FIG. 1B, and minimize heating of 504 and 504A corresponding to 103 in FIG. 1B.

Although the design in FIG. 5A is aimed more at cladding with a wide arc-facing electrode, a modification may lend itself to welding yet retain the symmetry. Referring to FIG. 5B, the one-piece design of the tube is broken into multiple, electrically isolated non-consumable electrodes 514A, 514B, 514C, for example, extending from respective electrode holders 517A, 517B, 517C, with each electrode having a pointed end, allowing arc focus for high energy density. Within torch body 510, the non-consumable electrodes 514A, 514B, 514C are arranged in a circle around a centrally located consumable wire electrode 513 advanced from a contact tip 511. Nozzle 512 encloses all of the electrodes 513, 514A, 514B, 514C and provides laminar gas flow 515 between the circle of non-consumable electrodes 514A, 514B, 514C, and consumable electrodes 513. A switching circuit directs current from the CC power source 518 to multiple non-consumable electrodes through semiconductor switches 519A, 519B, and 519C (e.g., power metal oxide silicon field effect transistors (MOSFETs) or an insulated-gate bipolar transistors (IGBTs)) to individually enable a focused TIG arc through one electrode at a time, but transfer the arc among multiple electrodes arranged in a circle at a nominal frequency, thus creating a rotating arc at a frequency at least one order of magnitude higher than the time constant of thermodynamics of the weld pool. To ensure there is no arc outage, the current transition between electrodes has a small overlap so that for a brief moment, two non-consumable electrodes are energized simultaneously during the overlap time.

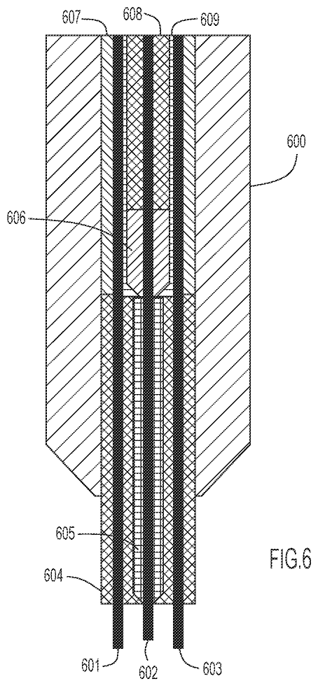

FIG. 6 shows a torch body front end 600 that supports three consumable electrodes or wires. Two consumable electrodes 601 and 603 are electrically connected and receive arc current from a same contact jaw 604. A third consumable electrode 602, in the middle, is isolated from contact jaw 604 via a ceramic tube 605 and receives arc current from contact tip 606 held by a holder 608. Both contact tip 606 and holder 608 are isolated from consumable electrodes 601 and 603 via nonconductive sleeves 607 and 609. The circuit depicted in FIG. 1C may be used to supply current, wherein consumable electrodes 601 and 603 in FIG. 6 correspond to 103A and 103B in FIG. 1C, and consumable electrode 602 in FIG. 6 corresponds to 106 in FIG. 1C. The torch of FIG. 6 is unique in that the center electrode is electrified and not cold. By shunting arc current away from the workpiece, less heat input and more freedom in process control to adapt to stick-out variations may be achieved.

Efficient electrode cooling is one key to produce a focused arc from a non-consumable electrode without an arc constricting nozzle. One challenge is the heat transfer out of the non-consumable electrode and the electrode holder, which is the first barrier in the heat transfer path. FIG. 7A shows a non-consumable electrode 700 that may be made using additive manufacturing or 3D metal printing techniques, and more specifically, binder jetting. It is a functionally graded material (FGM) where an arc facing end 701 is made of 100% refractory material such as thoriated tungsten (W). The composition shifts into blending some copper alloy or copper composite suitable for heat sink or heat exchanger (e.g., CuZn, CuCrZr, WCu, or MoCu) to 75% W and 25% Cu in position 702. In position 703, the composition shifts to 25% W and 75% Cu. Finally, in position 704, the composition is at 100% Cu alloy or a composite. Besides Zn, Zr, W and Mo, the copper alloy may also comprise Ag, Al, Be, Cr, Mg, Ni, Sn, Te or a combination thereof. An internal liquid cooling channel can be built into the non-consumable electrode 700, where liquid coolant (not shown) enters at ingress opening 705 and exits at egress opening 706, reaching as close as possible to the arc for maximum heat transfer efficiency. FIG. 7B illustrates the same principles for a non-consumable electrode 710 except for a different routing of the interior liquid channel. Additively manufactured components can be used in non-consumable electrodes shown in FIGS. 1A-1C, FIGS. 2A-2B, FIG. 3, FIGS. 5A-5B. The alloys or compositions used are for illustration purposes only and should not be misconstrued as a formula of optimum design.

The advantages of the above-described process can be summarized as follows. Due to its high energy density, the system design may be used as a “poor-man's” laser to increase productivity and quality and reduce production costs without the high capital cost of the laser. The adage “less is more” is more relevant in actual production than scientific research in the lab for reliability and uptime, thus a single-wire, single (combined) arc solution is more attractive than more complex multi-wire or multi-arc solutions such as tandem MIG, HyperFill and SuperMIG, and without the limitations of single-wire/high deposition solutions such as sub-arc and D-Arc for similar gains in a heavy plate or high-speed welding. Due to higher energy density, the embodiments described herein may outperform TIG-cold/hot wire variants such as TOPTIG, TipTig, and TIGer in heavy plate welding with fewer passes, less distortion, and higher deposition. For thin and heat-sensitive materials, the adage also applies when comparing to the motor needed for a reciprocating wire feed in CMT and possibly with fewer fumes and spatter in certain materials. The described system has portability benefits of carrying the heat source on a tractor in an open shop floor or an outdoor work environment versus an enclosed gantry with a large floor space often needed by a laser. For a fabricator with predominantly arc welding as competency, adopting a higher performance and more flexible arc process is easier and less costly than a new process like a laser, especially in a retrofit. Moving from arc welding to laser welding often requires a design change in the joint, which often precipitates a weld re-qualification that may cost hundreds of thousands of dollars or more in some high-value products such as jet engines and nuclear vessels, which may be avoided. Lastly, the system also offers versatility due to a broad spectrum from thin to thick plate and from low to high heat from independent control of heat and deposition. This versatility can be appreciated by ease of training, maintenance, and volume economics of standardizing on the same tool/process for a wide variety of applications, e.g., heavy plate welding, anti-corrosion cladding, repair, and pipe shop orbital welding, and thin sheet welding.

What is claimed is:

1. An arc welding apparatus comprising:
a torch;
a non-consumable electrode and a consumable electrode both disposed within the torch;
a wire feeder configured to feed the consumable electrode in a vicinity of the non-consumable electrode;
a first power source and a second power source that provide independent current, respectively, to the non-consumable electrode and the consumable electrode; and
a weld process controller to control outputs of the first power source and the second power source such that a concentrated arc is formed, as a heat source, between the non-consumable electrode and a workpiece, and an inter-electrode arc is formed between the consumable electrode and the non-consumable electrode.

2. The arc welding apparatus of claim 1, wherein the torch comprises a shielding gas nozzle enclosing both the non-consumable electrode and the consumable electrode such that ends of the non-consumable electrode and the consumable electrode are spaced apart by a distance of about 1-8 mm.

3. The arc welding apparatus of claim 2, wherein the shielding gas nozzle is one of oval or circular.

4. The arc welding apparatus of claim 1, wherein the weld process controller is configured, to control heat input and deposition independently.

5. An arc welding apparatus comprising:
a power supply;
a torch having a shielding gas nozzle enclosing a consumable electrode and a non-consumable electrode, the consumable electrode and the non-consumable electrode being electrically isolated from one another, and the non-consumable electrode is positioned inside the shielding gas nozzle and surrounds the consumable electrode in a coaxial and symmetrical arrangement; and
the consumable electrode and the non-consumable electrode both being connected to the power supply and configured to enable a first arc to form between the consumable electrode and the non-consumable electrode and to enable a second arc to form between the non-consumable electrode and a workpiece,
wherein electrical current levels of the first arc and the second arc are independently controllable by the power supply.

6. The arc welding apparatus of claim 5, wherein ends of the consumable electrode and the non-consumable electrode are spaced apart by a distance of about 1-8 mm.

7. The arc welding apparatus of claim 5, wherein the non-consumable electrode is tube-shaped and is formed as a single piece.

8. The arc welding apparatus of claim 5, wherein the non-consumable electrode is a multi-segment electrode, wherein segments of the multi-segment electrode are electrically isolated from one another.

9. The arc welding apparatus of claim 8, wherein the segments of the multi-segment electrode are configured to share an output of the power supply through a switch network.

10. The arc welding apparatus of claim 5, wherein the non-consumable electrode is flat and is formed as a single piece.

11. The arc welding apparatus of claim 5, further comprising a magnetic arc steering device or a magnetic field arc forming device adjacent the shielding gas nozzle.

12. The arc welding apparatus of claim 5, wherein the non-consumable electrode comprises refractory properties for TIG and plasma welding.

13. The arc welding apparatus of claim 12, wherein the non-consumable electrode is functionally graded or compositionally graded.

14. The arc welding apparatus of claim 12, wherein the non-consumable electrode includes an internal liquid cooling channel.

15. The arc welding apparatus of claim 12, wherein the non-consumable electrode is 3D printed.

16. A welding method comprising:
in a torch having a shielding gas nozzle enclosing a consumable electrode and a non-consumable electrode positioned inside the shielding gas nozzle and surrounding the consumable electrode in a coaxial and symmetrical arrangement, controlling a power supply to deliver electrical current to the consumable electrode and the non-consumable electrode to form a first arc between the consumable electrode and the non-consumable electrode and to form second arc between the non-consumable electrode and a workpiece,
wherein the electrical current delivered to the consumable electrode and the non-consumable electrode is independently controlled.

17. The welding method of claim 16, further comprising resistively heating the consumable electrode by at least one contact tip.

18. The welding method of claim 16, further comprising concentrating the second arc by super-cooling the non-consumable electrode.

19. The welding method of claim 16, further comprising concentrating the second arc with a plasma constricting nozzle near a tip end of the non-consumable electrode.

20. An arc welding apparatus, comprising:
a torch body;
a contact jaw disposed in the torch body and configured to support a first welding wire and a second welding wire;
a holder disposed in the torch body configured to support a third welding wire, the holder being electrically isolated from the contact jaw;
a first power source supplying current between (a) the first welding wire and the second welding wire and (b) a workpiece; and
a second power source supplying current between (a) the first welding wire and the second welding wire and (c) the third welding wire,
wherein the first power source and the second power source are independently regulated.
